(19) United States
(12) Patent Application Publication
(10) Pub. No.: US 2023/0027450 A1
(43) Pub. Date: Jan. 26, 2023

(54) SYSTEM AND METHODS FOR CREDIT UNDERWRITING AND ONGOING MONITORING USING BEHAVIORAL PARAMETERS

(71) Applicant: Albe Information LTD., Kiryat Ono (IL)

(72) Inventor: Ronen Chen, Givatayim (IL)

(73) Assignee: Albe Information LTD., Kiryat Ono (IL)

(21) Appl. No.: 17/946,344

(22) Filed: Sep. 16, 2022

Related U.S. Application Data
(63) Continuation of application No. 17/064,636, filed on Oct. 7, 2020.
(60) Provisional application No. 62/911,514, filed on Oct. 7, 2019.

(51) Int. Cl. G06Q 40/02; G06F 16/25; G06F 16/2458; G06F 16/9536

(52) U.S. Cl. CPC G06Q 40/025; G06F 16/258; G06F 16/2465; G06F 16/9536

(57) ABSTRACT

Embodiments of the present disclosure may include a method for credit underwriting, the method including receiving a dataset of user details. Embodiments may also include creating a convolutional neural network (CNN) with the dataset of user details. In some embodiments, the convolutional neural network organizes at least a portion of the dataset of user details into a layered and weighted dataset. Embodiments may also include creating an enriched layered and weighted dataset. Embodiments may also include executing a back-propagation operation to remove at least a portion of the layered and weighted data from the layered and weighted dataset. Embodiments may also include receiving a plurality of enriched layered and weighted datasets.

### CROSS-REFERENCE TO RELATED APPLICATION

This application claims priority to U.S. Non-Provisional patent application Ser. No. 17/064,636 filed Aug. 30, 2021, titled “System and methods for credit underwriting and ongoing monitoring using behavioral parameters” which is incorporated by reference in its entirety.

### COPYRIGHT NOTICE

A portion of the disclosure herein below contains material that is subject to copyright protection. The copyright owner has no objection to the reproduction by anyone of the patent document or the patent disclosure as it appears in the Patent and Trademark Office patent files or records, but otherwise reserves all copyright rights whatsoever

### BACKGROUND

The present disclosure relates to systems and methods for credit underwriting and ongoing monitoring using behavioral parameters of an individual or a business in need thereof. More particularly, analyzing online private and public databases, as well the user's own digital device(s) to create a personalized behavioral digital fingerprint of the risk associated with extending credit to that user or the business they represent.

In the financial world, banks, credit issuers and other financial institutions extend credit to businesses or individuals. Current quantified risk models are used to assess the risk to the credit issuer to decide the size of the loan or credit line and the interest rate (derived from a risk assessment of the applicant), all in accordance with the client's consumer history.

But in recent years, credit issuers have begun to recognize that they cannot safely give credit to a “casual,” unknown customer (perhaps an account holder of another bank) without access to financial information. These circumstances arise typically when the credit provider does not have comprehensive financial picture of the customer, making the possibility of extending/receiving credit almost non-existent, and both parties lose. The need to increase the customer base on the one hand, and to be diligent about risk on the other hand, has led institutions to seek new and varied solutions to deploy as they carry out risk assessments for new, unknown customers, namely customers who have limited purchase history, and/or do not necessarily have financial data to inspect and by which to conduct the risk assessment

The commercial and social lives of businesses and individuals are increasingly carried out online through digital means. Financial institutions, such as credit card companies, banks, credit unions and the like, began to determine risk in extending credit and quantifying the risk in extending credit through credit line limitations and varying interest rates, by mining personal data generated by those businesses and individuals routinely through daily activities. Online data mining and aggregation, referred to sometimes as “dataveillance,” techniques has been used (sometimes surreptitiously) by lenders to collect behavioral attributes. Although behavioral scoring can be used, existing models exhibit several deficiencies. Moreover, the models, which track purchasing habits by businesses and individuals, were proven to be potentially discriminatory to minorities.

For example, lawsuit filed by the US FTC against the credit card issuer CompuCredit alleges consumers who used their cards for marriage counseling, bars and nightclubs, pawn shops, and massage parlors were viewed as high risk and their credit line was reduced accordingly, while shopping at Wal-Mart was allegedly counted against a consumer in other issuer's risk scoring model and resulted in reducing the line of credit extended even though the consumer himself had no negative history. Likewise, it was reported that using merchant locations, and/or merchant or purchase type can disproportionally affect minority groups.

These and other aspects are addressed by the following systems and methods.

### SUMMARY

Disclosed, in various embodiments, are systems and methods for credit underwriting and ongoing monitoring using behavioral parameters of an individual or a business in need thereof. More particularly, provided herein are embodiments of systems and methods for mining and analyzing online private and public databases, as well the user's activity on their own digital device(s) that do not involve purchase history, to create a personalized behavioral digital fingerprint indicative of the risk associated with extending credit to that user or the business they represent.

In an embodiment, provided herein is a computer-based method for credit underwriting and ongoing monitoring using behavioral parameters, implementable in a networked system comprising: an administration server (AS), the administration server including a network communication module; a first database (DB¹), operably coupled to the AS; a plurality of dynamic search engine (DSE) in communication with the AS and DB¹; a plurality of open databases (ODB), each ODB being in communication with at least one of the plurality of DSEs; a plurality of private databases (PDB) each PDB being in communication with at least one of the plurality of DSEs; and at least one client access terminal (CAT), in communication with the AS, wherein the AS further comprises a central processing module (CPM) in communication with the plurality of DSEs, and the at least one CAT, wherein the CPM further comprises at least one processor in communication with a non-volatile memory storage device having thereon a processor-readable media with a set of executable instructions, configured when executed to cause the at least one processor to: receive a credit request from the CAT; receive preliminary user details; activate at least one of the DESs; receive data associated with the user's behavior; calculate a behavioral digital fingerprint (BDF), the method comprises: upon receiving a credit request, and preliminary user details from the at least one CAT, obtaining user-authorization to access at least one of the ODBs, and/or at least one of the PDBs; activating at least one of the plurality of DESs for retrieving from at least one of: the ODBs, and the PDBs, data associated with the user's behavior; and calculating the user's BDF; based on the BDF, determining the risk associated with extending credit to the user; and if the BDF is above a predetermined threshold, advancing the credit to the user; continuously retrieving data associated with the user's behavior; and continuously modify the BDF.

These and other features of the systems and methods for credit underwriting and ongoing monitoring using behavioral parameters, will become apparent from the following detailed description when read in conjunction with the drawings, which are exemplary, not limiting.

Embodiments of the present disclosure may include a method for credit underwriting, the method including receiving a dataset of user details. Embodiments may also include creating a convolutional neural network (CNN) with the dataset of user details. In some embodiments, the convolutional neural network organizes at least a portion of the dataset of user details into a layered and weighted dataset.

Embodiments may also include creating an enriched layered and weighted dataset. Embodiments may also include executing a back-propagation operation to remove at least a portion of the layered and weighted data from the layered and weighted dataset. Embodiments may also include receiving a plurality of enriched layered and weighted datasets.

Embodiments may also include executing a classifier to segment the plurality of enriched layered and weighted datasets into at least a first-class dataset of enriched layered and weighted datasets and a second-class dataset of enriched layered and weighted datasets. Embodiments may also include associating at least a subset of the first-class dataset of enriched layered and weighted datasets with at least a subset of the second-class dataset of enriched layered and weighted datasets.

Embodiments may also include calculating a behavioral digital fingerprint (BDF) of at least a subset of the first-class dataset of enriched layered. Embodiments may also include applying the behavioral digital fingerprint (BDF) to the associated second-class dataset of enriched layered and weighted datasets. Embodiments may also include determining the risk associated with extending credit to the associated second-class dataset of enriched layered and weighted datasets based at least in part on the behavioral digital fingerprint (BDF). Embodiments may also include storing the plurality of enriched layered and weighted datasets to memory.

In some embodiments, the dataset of user details may include at least one of an identification parameter, an age, marital status, residential address, an employer, a principal place of business (PPB) address, a secondary residences (INT), a secondary place of business (SPB), an email address, a contact number, and a favorite color. Embodiments may also include receiving a dataset of user details further including accepting the dataset of user details from a credit request form. In some embodiments, the credit request form may be at least one of a loan, a personal line of credit, a business line of credit, a line of credit increase, a credit card, a credit card limit increase, and a credit rate.

In some embodiments, the public cloud-based infrastructure (Azure™ Amazon™ etc.), a hosted solution (TripleC™, NetVision™, Rack Space™, and the like) or a self-hosted solution (a private data center based on, for example, VMware™ or Hyper-V™ infrastructure. In some embodiments, the at least one open database (ODB) may be a public cloud-based infrastructure.

Embodiments may also include creating an enriched layered and weighted dataset may include searching at least one open database (ODB) with a dynamic search engine (DSE) and returning at least one user detail not present in the layered and weighted dataset. In some embodiments, the dynamic search engine (DSE) uses at least a portion of the layered and weighted dataset as an input to the dynamic search engine (DSE).

In some embodiments, the method may include, for each retrieved email address, determining whether the host domain may be free, or represents a uniform source locator (URL). Embodiments may also include executing a back-propagation operation to remove at least a portion of the layered and weighted data from the layered and weighted dataset may include associating a low strength score to a subset of the enriched layered and weighted dataset. Embodiments may also include discarding at least one subset of the enriched layered and weighted dataset associated with the low strength score.

Embodiments may also include executing a classifier to segment the plurality of enriched layered and weighted datasets into at least a first-class dataset of enriched layered and weighted datasets and a second-class dataset of enriched layered and weighted datasets may include executing a support vector machine. Embodiments may also include a behavioral digital fingerprint (BDF) of at least a subset of the first-class dataset of enriched layered and weighted datasets may be representative of at least one business representative and the associated second-class dataset of enriched layered and weighted datasets may be representative of a business.

In some embodiments, the rate of local unemployment may be compared and weighted based on a regional rate of unemployment. Embodiments may also include executing a back-propagation operation to remove at least a portion of the layered and weighted data from the layered and weighted dataset may include cross-referencing the enriched layered and weighted dataset with data retrieved from at least one open database (ODB) and at least one private database (PDB).

In some embodiments, the range of scoring for the data used to populated the data fields retrieved and cross-referenced from at least one of each ODB and at least one PDB, has a different scale. In some embodiments, the method may include normalizing the scoring for the data retrieved based on the scoring scale. In some embodiments, the method may include weighting each dataset of user details into a sub-grouping.

In some embodiments, the weighting may be performed for at least one of the open database (ODB) and at least one private database (PDB). Embodiments may also include determining the risk associated with extending credit to the associated second-class dataset of enriched layered and weighted datasets based at least in part on the behavioral digital fingerprint (BDF) may include calculating a plurality of risk scores. Embodiments may also include selecting at least one risk score based at least in part on a business credit request.

In some embodiments, the method may include accessing a business bank account. Embodiments may also include determining the number of days over a predetermined period where the balance in the business bank account was below a predetermined balance. Embodiments may also include determining the number of times over the predetermined period where a balance of the business bank account was overdrawn.

### BRIEF DESCRIPTION OF THE FIGURES

For a better understanding of the systems and methods, with regard to the embodiments thereof, reference is made to the accompanying drawings, in which:

FIG. 1 is a schematic illustrating an embodiment of the components of the systems and their internal interaction;

FIG. 2 is a flowchart illustrating the internal flow of the system's major layers;

FIG. 3 illustrates the structure of the employed strategy layers and their interrelationship; and

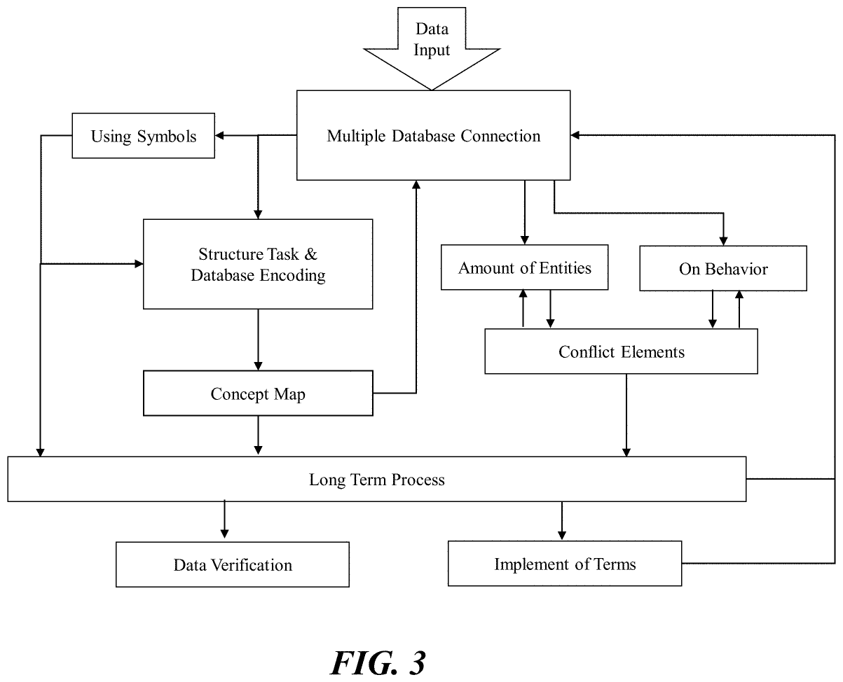

FIG. 4, illustrates the result of the generated engine in activating the various strategies to provide the AH index (BDF).

FIG. 5 illustrates a the creation of a nero network from user profile data.

FIG. 6A is a flowchart illustrating a method, according to some embodiments of the present disclosure.

FIG. 6B is a flowchart extending from FIG. 6A and further illustrating the method, according to some embodiments of the present disclosure.

FIG. 7 is a flowchart further illustrating the method from FIG. 6A, according to some embodiments of the present disclosure.

### DESCRIPTION

Provided herein are embodiments of a system applying a unique data mining and data integration method to personalize the risk assessment of extending credit to an individual or business based on their behavior, facilitating access to loans, credit lines, and credit. In another embodiment, provided herein are embodiments of systems and methods analyzing online private and public databases, as well the users' own digital device(s) to create a personalized behavioral digital fingerprint indicative of the risk associated with extending credit to that user, or the businesses they represent.

The disclosed technology is configured to provide an optimal risk management process. The systems and methods disclosed can create a live network (in other words, a structured holding of different types of connections between the lending institution, the underwriting entity, and the consumer (in other words, all stakeholders). This network of interrelated entities (e.g., businesses and individuals), is used to assess the risk involved in extending credit, and is later used as an input to a behavioral scoring algorithm that is not dependent on purchasing history. The module providing the final behavioral digital fingerprint of the target individual and/or company can be dynamically and continuously tunable to adapt to the changes experienced by the individual and/or company.

The disclosure provides connections, context, activation points, structured processes automatic processes as well as those requiring the input of a system administrator while operating autonomously as a learning system.

Accordingly and in an embodiment, provided herein is a computer-based method for credit underwriting and ongoing monitoring using behavioral parameters, implementable in a system comprising: an administration server (AS), the administration server including a network communication module; a first database (DB¹), operably coupled to the AS; a plurality of dynamic search engine (DSE) in communication with the AS and DB¹; a plurality of open databases (ODB), each ODB being in communication with at least one of the plurality of DSEs; a plurality of private databases (PDB) each PDB being in communication with at least one of the plurality of DSEs; and at least one client access terminal (CAT), in communication with the AS, wherein the AS further comprises a central processing module (CPM) in communication with the plurality of DSEs, and the at least one CAT, wherein the CPM further comprises at least one processor in communication with a non-volatile memory storage device having thereon a processor-readable media with a set of executable instructions, configured when executed to cause the at least one processor to: receive a credit request from the CAT; receive preliminary user details; activate at least one of the DESs; receive data associated with the user's behavior; calculate a behavioral digital fingerprint (BDF), the method comprises: upon receiving a credit request, and preliminary user details from the at least one CAT, obtaining user-authorization to access at least one of the ODBs, and/or at least one of the PDBs; activating at least one of the plurality of DESs for retrieving from at least one of: the ODBs, and the PDBs, data associated with the user's behavior; and calculating the user's BDF; based on the BDF, determining the risk associated with extending credit to the user; and if the BDF is above a predetermined threshold, advancing the credit to the user; continuously retrieving data associated with the user's behavior; and continuously modify the BDF.

In the context of the disclosure, the term “open database” or ODB, or their derivative, refers to information database that can be found on a wide area network (e.g., the Internet) and is open to the public. These can be, for example: Post Office, Stock Exchanges, Corporate Registrar, various government agencies and the like. Likewise, in the context of the disclosure, the term “private database” or PDB and their derivatives, refer to a closed set of information data requiring governmental authority to access. Generally these sources of information are quite reliable information sources, with high data quality and advanced data classification.

The behavioral digital fingerprint, or BDF, refers in the context of the disclosure to the final output of the method following the mining, analysis and continued monitoring of the data obtained by the system.

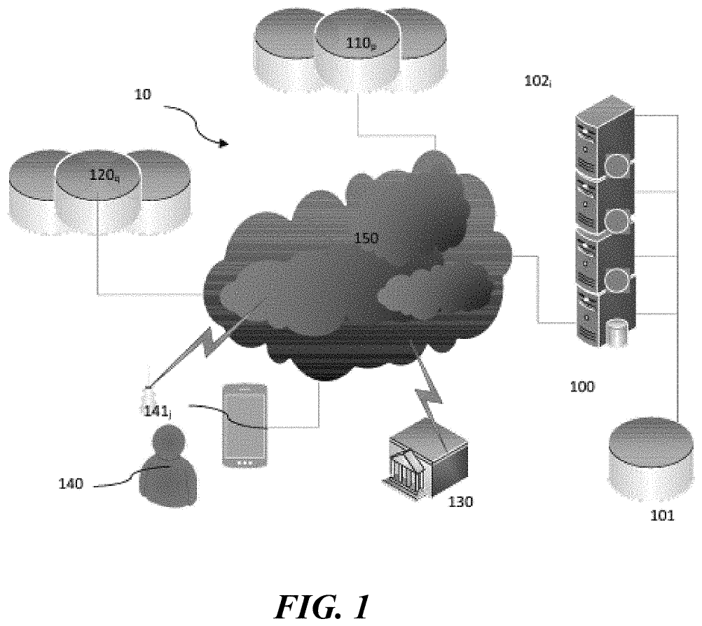

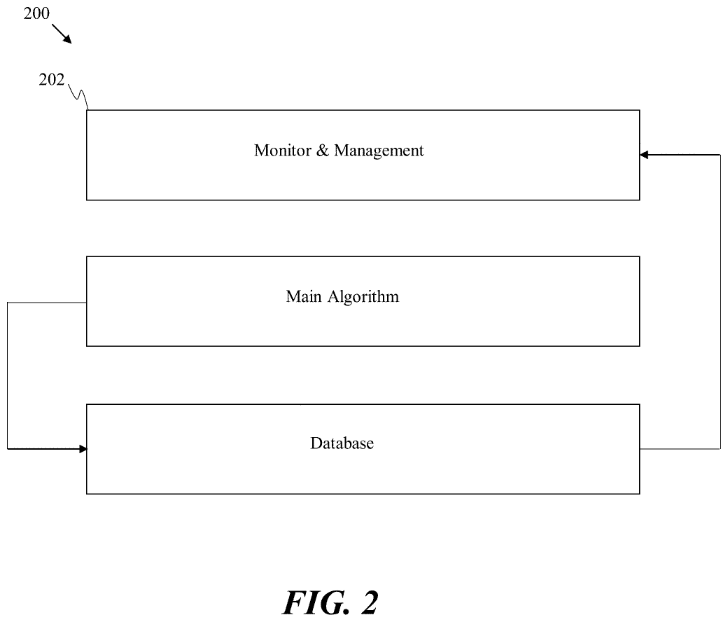

In an embodiment, the systems (an embodiment of which is illustrated schematically in FIG. 1), and method disclosed herein generate a dedicated Data Network Interface, is of a base layer network as well as a plurality of continuously active search engines. Once the algorithm is activated, regardless of which data is being received by the system (e.g., from ODB or PDB or other online and device sources), the network is configured to automatically transfer the information to the AS. This layer (e.g., AS layer, see e.g., FIG. 2), passes the information into DB¹ for more extended analysis and storage. After the information enters DB¹—a plurality of active search engines (e.g., three) are activated. The activity of these engines is based on engaging parallel processes described herein, where each engine has thereon a set of executable instructions configured, when executed to cause the engine to perform several levels of automated information gathering processes, with the intention to create continuous mining of data of every borrower or individual requesting a loan and/or service from the system.

As illustrated in FIG. 2, the systems and methods described will be comprised of the middle tier (layer) where the system provides a “service” to the management and monitor tier (Monitor & Management Layer) and to the Database layer that contains all the stored and continuously analyzed information received from open sources and closed sources databases.

The system can either be a public cloud based infrastructure (Azure™ Amazon™ etc.), a hosted solution (TripleC™, NetVision™, Rack Space™, and the like) or a self-hosted solution (a private data center based on, for example, VMware™ or Hyper-V™ infrastructure and the like). In addition, multiple levels of redundancy can be employed for the system (geo-replication, CDNs, load balancing, backups). The system will be monitored to make sure all required resources are available and operating as expected.

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory of the AS 100. AS 100 may also contain communication channels that allow the computing system 100 to communicate with other processors, for example, the plurality of search engines 102ᵢ.

Embodiments described herein may comprise or utilize a special purpose or general-purpose computer including computer hardware, such as, for example, one or more processors (e.g., central processing module, CPM) and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

The systems and methods described herein can be implemented in a computer system that includes a back-end component, such as a data server, or that includes a middleware component, such as an application server or an Internet server (see e.g., search engines 102ᵢ), or that includes a front-end component, such as a client access terminal (CAT) 141ⱼ having a graphical user interface (GUI) or an Internet browser, or any combination of them. The components of the system can be connected by any form or medium of digital data communication such as a communication network. Examples of communication networks include, e.g., a LAN, a WAN, and the computers and networks that form the Internet.

As illustrated in FIG. 1, the system can comprise various modules, open databases ODBs) 110ₚ, which is different than the private databases (PDBs) 120_{q}. Also illustrated are AS 100, configured to process the information and data retrieved from the databases 110p, 120q and DB¹ 101 to facilitate the methods and data network interfaces described. Data retrieved can be stored in DB¹ 101 for continuous monitoring of the parameters used to generate the BDF and if need be, adjust the credit terms during its lifetime. The Rule based engine can be adapted to periodically retrieve additional data (e.g., updating preferred color over time) and use it to recalculate the BDF. Also illustrated in FIG. 1, are third party stakeholder 130, such as the loan provider or credit issuing entity.

The system can have various additional components, for example; a Web Client—From the end-user's point-of-view configured to render web pages supporting a credit request flow. The system can also be adapted to support all modern desktop web browsers (e.g., Latest Chrome, Firefox, IE10+). The system can consist of, for example—application servers serving all synchronous web requests 141 to end users 140. The application servers can be configured to run as a backup for each other for redundancy purposes and utilize a platform load balancer to route incoming requests and distribute the load. Additional application servers can be easily launched, should the need to support heavier loads arise during operation. The main utility of the application server is to register incoming requests for credit and to provide the preliminary details to the users and/or operators after the information mining process (in other words, the retrieving of data from external ODB 110p and PDB 120q) is complete (in other words, “bottom-up” approach). However, the AS does not need necessarily to perform the actual information mining and data processing, in order to prevent long lag on web requests. These can be executed by web servers 102i.

Web servers 102ᵢ—The actual information mining tasks can be configured to be performed by the workers layer. As mentioned, the AS receives the initial input (in other words, the preliminary data input) from the end-user 140 requesting the credit.

In addition, the CPM used in the computer-based system for credit underwriting and ongoing monitoring using behavioral parameters described herein can be adapted to be in communication with the plurality of DSEs, the at least one CAT the network communication module and a behavioral scoring module.

The term “module” is used herein to refer to software computer program code and/or any hardware or circuitry utilized to provide the functionality attributed to the module. Further, the term “module” or “component” can also refer to software objects or routines that execute on the computing system. The different components, modules, engines, and services described herein may be implemented as objects or processes that execute on the computing system (e.g., as separate threads).

The disclosed method utilizes a number of strategies to provide a behavioral digital fingerprint of the user indicative of the risk associated with extending the user or the business they represent with credit. These strategies can be, for example, communicating with plurality of open and private databases; performing task structuring and database encoding; use a predetermined set of markers representing the user's behavior; generate a concept map; perform quantitative parameter analysis; use existing behavioral schemes; provide conflicting element; and collect persistent, long-term behavioral parameters.

For example, in communicating with plurality of open and private databases, the strategy is based on obtaining input (initially from the user filling web-based forms), for a number of data fields, cross-referencing the input data with additional information and creating an Initial information layer (from each repository e.g., ODB, PDB) for transfer into the algorithm. The information collected can be entered under the field. In other words, using the preliminary user details, populating a plurality of data fields; cross referencing the populated data fields with validating data from a source that is different than the data source used to populate each data field; forming a preliminary data layer; delivering the preliminary data layer to the DB¹.

The preliminary data entry provided by the user, can be at least one of: an identification parameter (e.g., social security number, tax ID number); age; marital status; residential address (street, city, zip code) or principal place of business (PPB) address (street, city, zip code); number of secondary residences (INT), or number of secondary place of business (SPB); email address(es); and favorite (e.g., preferred) color.

Each data field completed using the initial preliminary data form fulfilled by the user, either when requesting credit in the form of a loan, line of credit, credit card drawing limit and the like, and when relevant—the attendant interest rate, either for themselves(s) as individual(s) or in the name of a business, will be validated using at least two different OPBs or CPBs or their combination. For example, in certain jurisdictions, verifying marital status can be done from two OPBs. Additionally, the: age, marital status, number of secondary residences, or SPBs, and favorite color, are each associated with a predetermined sub-group, the sub-group associated with risk of extending credit to the user and are weighted and scored accordingly. Moreover, since each data entry to each data field is validated using at least two different sources (ODBs, PDBs, e.g.,), the source database will be weighted according to predetermined weighting and the final score for the sub grouping will reflect the fractional weighting for the data source used. In addition, in another example, the range of scoring for the data entries used to populated the data fields retrieved and cross-referenced from at least one of: each ODB and at least one PDB, (the range) has a different scale, and wherein the method comprises normalizing the scoring for the data retrieved based on the scoring scale.

For example, the retrieval of a corroborating data from at least one database will cause the scoring for marital status as follows:

TABLE I
Marital Status

| No | Type | Selection | ODB1 | ODB2 | Weight |
|---|---|---|---|---|---|
| X | Marital Status | Unmarried | 0 | 0 | 0 |
| | | | 0 | 1 | −1 |
| | | | 1 | 0 | −1 |
| | | | 1 | 1 | −1 |
| | | Widowed | 0 | 0 | 0 |
| | | | 0 | 1 | −1 |
| | | | 1 | 0 | −1 |
| | | | 1 | 1 | −1 |
| | | Divorced | 0 | 0 | −1 |
| | | | 0 | 1 | −1 |
| | | | 1 | 0 | −1 |
| | | | 1 | 1 | −1 |
| | | Married, no Children | 0 | 0 | −1 |
| | | | 0 | 1 | 1 |
| | | | 1 | 0 | 1 |
| | | | 1 | 1 | 1* |
| | | Married with Children | 0 | 0 | −1 |
| | | | 0 | 1 | 1 |
| | | | 1 | 0 | 1 |
| | | | 1 | 1 | 1* |

*denotes a warning will be issued.
“0” indicates no record validated in ODB and 1 indicates a record for the selection is found.

Similar sub-grouping can be done to other data-field entries, which will be indicative of the risk for the loan or credit line provider in extending credit.

With regard to the residential address, and/or PPB, the system can further for the residential address of the user, and each secondary residence(s): access a database configured to provide a lien, or mortgage on the property and score accordingly, and additional data on rate of local unemployment; and for each location of primary or secondary residence, retrieving the rate of local unemployment and if the local unemployment is lower than the rate of a regional (e.g., county, state, province, and the like) rate of unemployment, provide a score of +1; else if the local unemployment is the same as the rate of a regional rate of unemployment, provide a score of +1; else if the local unemployment is higher than the rate of a regional rate of unemployment, provide a score of −1.

Furthermore, for each retrieved email address, determining whether the host domain is free, or represents a uniform source locator (URL) of a web address. If the host domain represents a URL, the method further comprising: extracting the URL's central pixel color; verifying the presence of a matching profile for the URL on Facebook social network; verifying the link connection to the URL; scoring the email address based on the presence of the matching profile, and the link connection of the URL; and storing the score and the URL's central pixel color in DB¹. In other words, once it is determined that the host domain name (@XXXXX.YYY) represents a website, an averaging method is used to obtain a kernel that is preferably small, (e.g., 3×3, 4×4, 5×5) taking into account the pixels in the immediate neighborhood, and centrally weighted, which puts more weight on the contribution from the central pixel color. The central pixel color is a feature extracted from each such website. Moreover, the system and methods disclosed herein are further configured to validate whether the host domain name has an entry on various social networks, such as Facebook, LinkedIn, WeChat and the like.

An example of the pseudocode used to import assign of data from one of the social networks disclosed, convert the data, and encoding the string before saving it in DB1:

```
import assign_to_check.ArithEncoderDecoder;
public class Main {
  private static final String inputFileContent =
“12345678953279416783469835797378342394830735020284753”;
  private static final String outputFileContent =
“00000011000000100000010100001010000001100000010100000011000010000000011
000000101000011111010011001000011100111101101010001001010001011010010111
100100110010011010101110010100100000000110100011000101000000101111001001
110100011001010010101000101000110011101100111101111101100000111010000110
110111011010110110100000001011100010011000110111111010110011111000101110
000011110100101101100001111011111100000101110011001011001001000001010001
000101101100011111111111100100011001011101110011100011001001001110010010
101100001110010100010101101111010000101101011011111101101111110001011111
101100101110110110101110110011101001010001011101001011110100010101110011
001010101111100011111011101001010000101001101101000001001101101010110111
101111100000001011101110000011000111101110101101011000101111101010010101
110110111011001001010010100001000000001111001110111001100001011000101001
110100000101010101111010000000111111010110110010001010101011111010001001
010111011011011001010110010011011100110010011101111000000110100111111001
101011000110110101000111101110000110111111011011011100111101010111101010
101011001010001001111110010001101001110101001100010111011101100001101010
001010111011100001110000010001110100100110011100100001100110000101111110
111000000101000001001101101000111000001110000111101011111111011010011100
010110110100100101001111100000110010010100111010011011010100111111100010
101011111011111111010110010010111011000101011100111111101110000111111111
010000000010111001100000111101000110010100100011010111010000101100110000
010010000010111101100000010001100111010110000010001011101101101001110101
010100110000011001101011101110011010000101111110110011101000111010001011
111110101001100101100001010010101011111100001001110111101000000011011010
100010111000111111010001001101000110000110011011110111001011100110101000
000101111110110101111001100001010100000111010111010110110110111000000011
100011001101110010001011100100011111000101010000010000000111001100101000
110001011100001010101101000000000100010001001111011111110010000001000001
000010001110011001001011011101010110000111111001000000001101011110000110
110111101100110011001101000010101011010100111011101101111100110111101101
010111101010001101110101101001001111010101000000101001110101100000010010
111000111100000100100110000100001110001110100100000110010101000100010000
010111000001000000111110110111011100011111101010110101110101010111010110
010011101111011001100100111101101101010010001001110101111101110110101100
000011111010111101111010110001101111111100000011110101010011111011001001
000000111111001001001011111100100000101010001100011000011000101000110001
000110011101010011001010010101111000110000001000110001010001100101111111
000111111001010111000001100001100010101010011100000000101110111011010110
010000100101010000101110011011100100110001111011001110011011100111010010
110100110000001111101011111111011000110011100010110000110101011000110010
111111010001110101101001001001101100000101101011101010100001101010100000
001001100000010010010000110000101010000011010110011100001011010011110011
000010100010000010101110001011000011000111010011100010010011110101011101
110100100010000010111100100011001101100101001011000111011000111100111001
111010011110011000011101010111110011100111011011001010111111100001110100
111111100000100001000111011100000111101011100101011001110111000101001011
100010100100110001011110101001110101101010101011111110010011101110111100
010110110011101000110001010000100100111001000110010110100010110010000100
100011111101100001010110000101101000011101010010001000111111100011000101
011110000000000111101101110010110111110010011011001100110010110101111001
011101111000000010001000010001000110011011010001010011010100110001011010
100010000000100001110100011001101011011110111010010111010101001010001000
011000000001011011000000110100111010101000001001011110101110000011000001
101011001111001111001001011110111101010101110111011101110100111000100111
110110011000110001110001011000110100011110111011111101010000100100011101
011001100101011110100010010100110010110100010011111101000110111011011011
100101101100010000110001111001010000010011000001011101110101110100101010
111010100100011010011111011101011010110011000100111111010000011000100011
101101101111100101001011110000010010000101011000001010000000110110110010
010011100100100111110111000111101110001000111000100111001010100101011000
101000000111000110000110110110011001011111110010011100010111001001011100
111001110101001101100101011011010101111101101111111101110011111010010011
111010101001001110011001110110111110010100100100011101000011000101010011
100101100001011110010101001000001101111010101011001010000111110001111010
010011011011101001010100000011000101100001000010001101110110001110100110
010111101001011001011000011010110001111000000100010010001111000111100000
110110010001000000100000011001100110010010001100001011100100111101001000
010110100100011110001110000000010010011100101001011101100111010010011000
111000111001001101000101100011101100101000110001010101111000111000101000
110110110010000100001101001010001001100100110100110000011001001001110101
001001111010011100100010010111101011001000111010111001110100011000101101
000001010111111100000011000110001000011101000100110011001011110100100000
000111101010010011000010010011010110101010101111010000110110011110101000
001011010000110100101010111100010111011111101111001101011100011001011001
01101010111101000110110001100100100001111110110000011”;
  private static boolean check_Compress = true;
  public static void main(String[ ] args) {
      String[ ] inputs = new String[1];
      String[ ] outputs = new String[1];
      inputs[0] = inputFileContent;
      System.out.println(“Starting to check new assign”);
      System.out.println(“− input content is ” + inputFileContent);
      System.out.println(“− output content is ” + outputFileContent);
      long startTime = System.currentTimeMillis( );
      try {
          ArithEncoderDecoder arithEncoderDecoder = new
          ArithEncoderDecoder( );
          if (check_Compress) {
          If (check_compress) %% arth (%%%)
            arithEncoderDecoder.Compress(inputs, outputs);
          } else {
            outputs[0] = outputFileContent;
            inputs=new String[1];
            arithEncoderDecoder.Decompress(outputs, inputs);
          }
          long endTime = System.currentTimeMillis( );
          System.out.println(“Total running time is ” + (endTime − startTime) + “ milis”);
      } catch (Exception ex) {
          System.out.println(“Running encoderDecoder ends with exception ” +
ex.getMessage( ));
          return;
      }
      verifyEncoderResult(inputs, outputs);
  }
  private static void verifyEncoderResult(String[ ] inputs, String[ ] outputs) {
      if (check_Compress && outputs[0].equals(outputFileContent)) {
          System.out.println(“Output file content is as expected - verification of
compressing succeeded!!!!”);
      } else if (!check_Compress && inputs[0].equals(inputFileContent)) {
          System.out.println(“Input file content is as expected - verification of
decompressing succeeded!!!!”);
      } else {
          System.out.println(“verification failed”);
      }
f(isCrossed == 1){
      ticket = OrderSend(Symbol( ),OP_BUY, LotsOptimized( ),Ask,3,0,0,“Double SMA
Crossover”,MAGICNUM,0,Blue);
      if(ticket > 0){
        if(OrderSelect(ticket, SELECT_BY_TICKET, MODE_TRADES))
          Print(“BUY Order Opened: ”, OrderOpenPrice( ));
        }
        else
          Print(“Error Opening BUY Order: “, GetLastError( ));
          return(0);
      }
  if(isCrossed == 2){
    ticket = OrderSend(Symbol( ),OP_SELL, LotsOptimized( ),Ask,3,0,0,“Double SMA
Crossover”,MAGICNUM,0,Blue);
    if(ticket > 0){
      if(OrderSelect(ticket, SELECT_BY_TICKET, MODE_TRADES))
        Print(“SELL Order Opened: ”, OrderOpenPrice( ));
      }
      else
        Print(“Error Opening SELL Order: ”, GetLastError( ));
        return(0);
    }
  }
  }
}
```

Similarly, in methods disclosed herein, the user selects their favorite color and the data entered whereby the color is selected from: Red, Yellow, Green, Blue, Black, and White, whereupon the system, based on the selection will provide initial scoring to the color selection. Again, choosing the favorite color is indicative of personality traits indicative of the risk in extending credit. The traits associated with the risk and corresponding scoring:

TABLE II
Color Selection Impact:

| No. | Field Type | Color | Score | Personality |
|---|---|---|---|---|
| X | Fav. Color | Red | 1 | Leader, decisive, requires results, |
| | | | | Management Skills |
| | | Yellow | 1 | Highly capable, sales people, |
| | | | | personnel mgrs. |
| | | Green | 0 | Altruistic, calm, relaxed |
| | | Blue | 1 | Highly analytic, driven by ideas, |
| | | | | financially savvy |
| | | Black | −1 | Conservative, mysterious |
| | | White | 0 | Calm, no ego |

Incorporation of the color selection into the behavioral scoring algorithm is provided herein:

```
<?php namespace BA\Colors;
class Colors
{
  private $colors;
  public function construct( )
  {
    $this−>colors = new \stdClass( );
    $this−>colors−>red = [‘1’, ‘1’, ‘0’];
    $this−>colors−>yellow = [‘1’, ‘1’, ‘0’];
    $this−>colors−>green = [‘0’, ‘1’, ‘0’];
    $this−>colors−>blue = [‘1’, ‘1’, ‘0’];
    $this−>colors−>black = [‘−1’, ‘1’, ‘0’];
    $this−>colors−>white = [‘0’, ‘1’, ‘0’];
  }
  public function getColorScore($color)
  {
    return $this−>colors−>$color !== null ? $this−>colors−>$color[0] :
    ‘ ’;
  }
  public function getDayScore($color)
  {
    $today = date(‘d’);
// echo ‘<pre>’;
// print_r($today); die;
    $return = 0;
    if ($today < 10) {
        $return = 1;
    } else if ($today >10 && $today <= 15) {
        $return = 2;
    } else if ($today > 10 && $today > 15 && $today <= 31) {
        $return = 2;
    }
    return $this−>colors−>$color[$return];
  }
}
```

In addition, the method will take into consideration which day of the month the form was filled, and what was the weather on that day and provide a complementary. Moreover, the incorporation of the weather conditions are taken for example, from available open databases. For example, whether the preliminary detail form was filled before the 10^{th} of the month, between the 10^{th} and 15^{th}, or after the 15^{th} In addition, whether the weather was sunny, rainy, partly sunny, partly cloudy and the like. All these parameters are used by the method executed by the set of executable instructions to provide a weighted complementary color score and further the method comprising: based on weighted preliminary color score, and weighted complementary color score, calculating a final color score which can then be used to compute the BDF.

An example of the incorporation of the weather condition into the algorithm is provided in the pseudocode disclosed herein:

```
<?php namespace BA\Weather;
class Weather
{
  private static $uuid= ‘fb37f1268d0045cf5e1209228d0c5857’;
  protected $city,
    $street,
    $score,
    $weather;
  public function _construct($city, $street = ‘ ’)
  {
    $this−>city = $city;
    $this−>street = $street;
    $this−>setWeather( );
  }
  private function setWeather( )
  {
    $ch = curl_init( );
    curl_setopt($ch, CURLOPT_URL, ‘api.openweathermap.org/data/2.5/weather?q=’ .
$this−>city . ‘&appid=’ . self::$uuid);
    curl_setopt($ch, CURLOPT_FOLLOWLOCATION, true);
    curl_setopt($ch, CURLOPT_RETURNTRANSFER, 1);
    $result = curl_exec($ch);
    if (curl_error($ch)) {
    } else {
      $result = json_decode($result);
      $weather = ‘ ’;
      if (isset($result−>cod) && ! empty($result−>cod) && $result−>cod === 200) {
        $cityDegree = $result−>cod;
        if (isset($result−>weather) && count($result−>weather) > 0) {
          $weather = strtolower($result−>weather[0]−>main);
          $this−>weather = $weather;
        }
        switch ($weather) {
          case ‘clear’:
            $score = 1;
            break;
          case ‘thunderstorm’:
            $score = 0;
            break;
          case ‘drizzle’:
            $score = 0;
            break;
          case ‘rain’:
            $score = 0;
            break;
          case ‘atmosphere’:
            $score = 0;
            break;
          case ‘clouds':
            $score = 0;
            break;
          default:
            $score = 0;
        }
        $this−>score = $score;
      }
    }
    curl_close($ch);
  }
  public function getWeather( )
  {
    return $this−>score;
  }
  public function getWeatherString( )
  {
    return $this−>weather;
  }
}
```

The methods and systems for underwriting line of credit based on behavioral digital fingerprint make use of Structure Task and Database Encoding strategy, which is based on data compression theory and built-in tasks after compression and reclamation of the Initial data. In other words, the process consists of a number of sub-processes where the mechanism presents data compression as well as a set of built-in assignments to receive additional data. To reiterate, the system is continuously working and learning the behavioral aspects of the user and fine-tunes the BDF.

Using a plurality of built in processes, the system generates a repeatable behavioral fingerprint of the borrower, whereby each process is independent but the combination of processes and their scoring is the one providing the most accurate BDF. For example, the processes can be at least one of: location consistency; Social network diversity; financial transactions; and stability in key relationship. Each process will have its own indicators and be scored accordingly.

For example, for assessing location consistency, the methods and systems for underwriting line of credit based on behavioral digital fingerprint can be configured to use the user's smartphone (CAT 141ⱼ, FIG. 1), and further to obtaining the proper authorization from the user; obtaining the smartphone location history over a predetermined period; determining the user profile on a plurality of social networks.

Furthermore, for each social network determined as relevant by the system administrator, the method further comprises: testing whether a user profile exists (either for the end user or the company they represent): determining recent activity on each social network where a profile exists (for example, over a predetermined time period, for example last 24 hours, last 12 hours, last 6 hours, last hour and the like); cross-referencing those recent activities among the plurality of social networks where a profile exists; and generating results of the crossed reference activity to DB¹ (see e.g., 101, FIG. 1).

It is noted that a behavioral part of users and businesses world is the need to be connected in the community and in social networks. Diversification of social networks allows the algorithm to gather more information about the potential borrower (and once approved, for continuous fine-tuning of the profile as expressed in the BDF), as well as the behavioral consistency among all social networks. For example, the social network can be at least one of: Facebook, LinkedIn, Instagram, YouTube, Twitter, Pinterest, WeChat, WhatsApp, Tumblr, Flickr, Reddit, Snap, Viber, Digg, Delicious, Telegram, Signal, Threema, and the like. Cross-connections can also be used to test multiple parameters on a single axis and compare those parameters on one timeline (T). For example, the borrower uses the WhatsApp app to correspond with someone, as well as Viber app to call using VoIP with the same person (up to 120 hours back) thus indicating cross-connection.

Moreover, and again to gauge the user's consistency as it pertains to their behavioral traits, the methods and systems for underwriting line of credit based on behavioral digital fingerprint can be configured for obtaining a representative picture central pixel color from each social network (e.g., LinkedIn, Facebook) where the user profile was determined to exist; comparing the picture central pixel to the URL's central pixel color (see above); and if the color in the picture central pixel is similar to the URL's central pixel color, scoring the colors as a match.

Another phase is the confirmation of a statement about the correctness of the information provided in the initial data entry by the user. Studies show that People cheat when they have the opportunity, but cheat far less than they are actually able. Moreover, the moment they think about honesty—whether by thinking about the Ten Commandments or by signing a simple statement—cheating drops drastically. In other words, as people move away from the standards of moral thought, the tendency is to err on the side of moral transgression. But if once reminded of morality at the moment of temptation, chances are people will act honestly. Accordingly and in another embodiment, the methods and systems for underwriting line of credit based on behavioral digital fingerprint can be configured for authorizing the reading of a statement concerning the veracity of the preliminary user details; and signing that authorization statement.

In an embodiment, the user requests the extension of credit for a business. Accordingly, the methods and systems for underwriting line of credit based on behavioral digital fingerprint can be configured for entering, in the preliminary data entry the following items: business identification number (such as tax ID number); business name; number of employees; years of operation; fulfillment service; telephone number; and PPB address (street, city zip code etc.,). Here too, the field: number of employees, years in operation, and fulfillment service, are each associated with a predetermined sub-grouping, the sub-grouping associated with risk of extending credit to the business.

It is further noted, that since the methods and systems provided herein are behavioral in nature, the number of employees is not used to compute the BDF, since there is no research indicating the connection between the number of employees and the underwriting risk for credit. However, that data is use for example, for long term monitoring and data validation. Nevertheless, the methods and systems for underwriting line of credit based on behavioral digital fingerprint can be configured for obtaining the primary residential address of the user; calculating the length of commute between the primary residential address of the user and the PPB address; and calculating a score based on at least one of the commute distance, and the time of commute; and storing the calculated score in DB¹, wherein, the commute distance and/or the time of commute is compared to a predetermined value associated with risk of extending credit to the business.

In addition, the systems and methods will continue the test operation (word shortcuts and mathematical symbols); by using, for example True Caller Website service: https://developer.truecaller.com/site, which will allow checking whether the phone number Entered into the borrower form for cross-referencing are matched with other databases.

Also, the methods and systems for underwriting line of credit based on behavioral digital fingerprint can be configured for determining the use of emoji by the user; and providing a score based on the emoji used. This analysis can be used to test the mood of the user under typical circumstances. This involves as well, sub-grouping the emoji, the sub-grouping associated with risk of extending credit to the user. For example, the emoji sub-grouping can be selected from the sub-groups comprising: smileys and people, animals and nature, food and drink, activities, travel and places, objects, symbols, or flags, each sub-grouping which is assigned a score which is further convoluted to provide the final BDF.

Additional behavioral parameter analyzed can be on foreign travel frequency and travel destination of the user. In this context, the methods and systems for underwriting line of credit based on behavioral digital fingerprint can further comprise: sub-grouping the travel destination; based on the sub-grouping, scoring the travel destination; and storing the calculated score in DB¹. Depending on the location of the individual, the travel destination associated with credit extension risk can change. An example of such sub-grouping can be Western Europe, Eastern Europe, Russia, Asia Pacific, China, Hong Kong, United States of America, South America, Central America, Mexico, South Africa, or Central Africa.

In circumstances where the user is a representative of a business, the systems and methods provided herein can be configured to assess the impact of the person filling the initial forms as a proxy for the behavior of the corporation in assuming the risk associated with extending the requested credit. To that end, in the methods and systems for underwriting line of credit based on behavioral digital fingerprint, the preliminary user details used for populating the data fields further comprises: the user role in the business; number of shareholders in the business; change in the number of shareholder over a predetermined period; and bounced business checks. In addition, determining the extent of using digital prescriptions used by the business for its employees. can be analyzed and used to get a view about the engagement of the business with the various health systems to gauge the health of employees and as a proxy, the risk involved in extending the credit to the business. Similar the number of shareholder can provide information about the stability of the business. To that end, if the number of shareholders is over a predetermined threshold, providing a BDF for each shareholder; and based on the shareholders individual BDF, calculating a weighted business BDF.

Specifically with regard to the bounced checks, the data field of bounced checks is crossed referenced by: accessing the business bank account; determining the number of days over a predetermined period where the balance in the bank account was below a predetermined balance (typically set by the bank and will affect a warning letter once the balance falls below that amount); and determining the number of times over the predetermined period (e.g., 6 months, 3 months 30 days backward), where checks bounced.

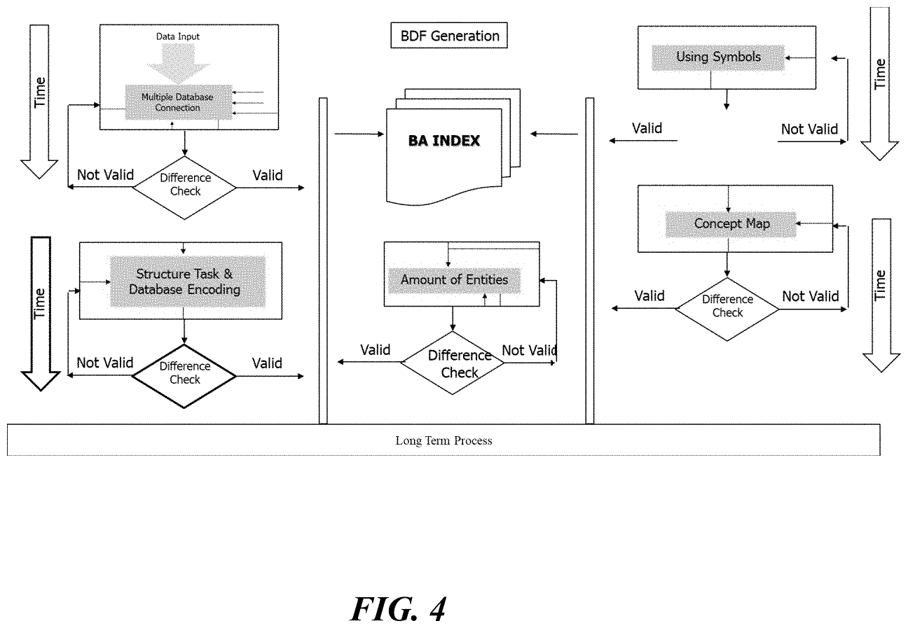

As illustrated in FIG. 4, although each strategy works independently and generates an answer, for each given answer a parameter of the BDF will be given validity. A difference of over 5% for the same parameter, using each strategy and fed to the final BDF will cause the same strategy to be recalculated. The recalculation can be done only after T+24 hours. Thereafter, the algorithm will be recalculated against the BDF. A 5% difference will send “Long-term process alert” and a recalculation will be performed. If the consequent calculation comes will result in a difference of 5%, the parameter will be re-updated and another round of (re) calculation will ensue at the end of the given generation regardless. It is noted that an economic-behavioral algorithm is a learning algorithm and can change at any given moment. It gathers and analyzes data that exits error as a closed-loop system.

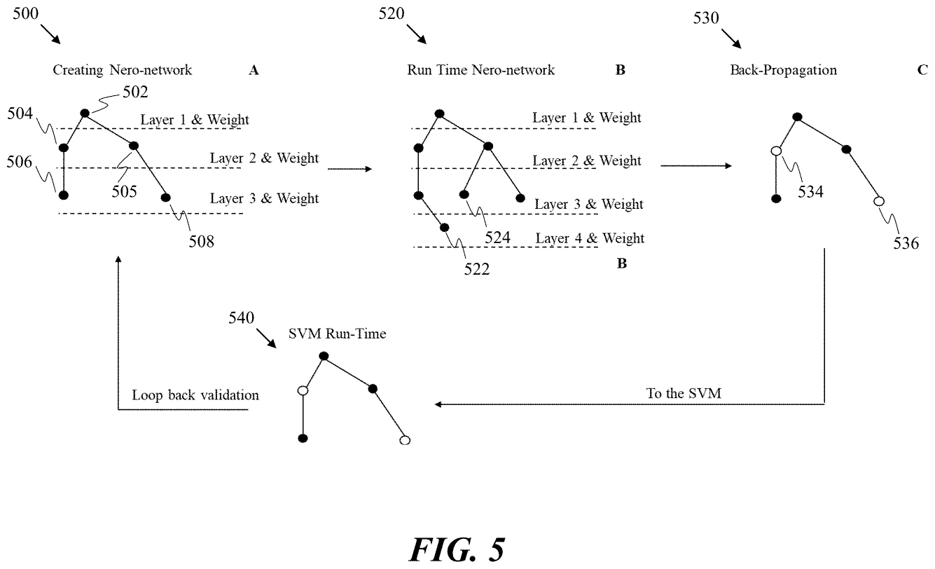

As illustrated in FIG. 5, a network server connected to a web application may receive a dataset of user details 502, 504, 505, 506, 508. The dataset of user details 502, 504, 505, 506, 508 are aggregated into layers and weights to create a nero-network profile 500 according to some embodiments of the present disclosure. The system may use the dataset of user details 502, 504, 505, 506, 508 to create a convolutional neural network (CNN) 500 with the dataset of user details 502, 504, 505, 506, 508. The convolutional neural network may organize at least a portion of the dataset of user details into a layered and weighted dataset. In some embodiments, the convolutional neural network (CNN) 500 may be enriched with new user details 522 and 524. In some embodiments, the server may use the dataset of user details 502, 504, 505, 506, 508 to search connected databases and return additional user details 522 and 524.

In some embodiments, a back-propagation operation may be implemented to remove at least a portion of the layered and weighted data 522 and 524 from the layered and weighted dataset 520. The back-propagation model 530 may include enriched layered and weighted datasets, including high-strength data 534 and 536. Strength may be selected from user details that have been validated, or the confidence level of the authenticity of the user detail is high. In some embodiments, one or more operations may be executed. For example, a classifier may be executed to segment the plurality of enriched layered and weighted datasets into at least a first-class dataset of enriched layered and weighted datasets and a second-class dataset of enriched layered and weighted datasets.

In some embodiments, to calculate and assess the level of credit risk, several algorithms may be implemented. A KNN neuron network could be used to denote and store the user details including: address, zip code, country, e-mail address. After building the network, the tree structure may be exported into another algorithm, for example, COBWEB. In some embodiments, COBWEB, performs clustering to a central balance point that represents the lowest credit risk.

The product of the algorithm may allow a single-valued scale bar on a linear axis to be identified and transmitted to a research group. The research group may reduce the standard deviation percentages by using a suitable algorithm, such as the Nash algorithm. In some embodiments, the Nash algorithm allows for the use of graph functions from which the smallest standard deviation as well as the risk level of the end user is determined. To perform the validation, an algorithm called back propagation may be implemented. The back propagation may be implemented to return the parameters to the KNN neuron network after performing the steps using the algorithmic funnel described above. Such a process may refine the existing binary tree and refine new customer data quickly, efficiently while finding the product (credit risk) quickly.

In some embodiments, to produce an accuracy percentage below 5%, it may be required to transmit through back propagation both the intensity and the axis layer on which the information sits. In some embodiments, this algorithm allows for manual manipulation in an early step determine relative reference values of the user data.

In some embodiments, a Support Vector Machine (SVM) may be implemented on a server. The SVM may be used to create an SVM-run time profile 540. The SVM-run time profile 540 associates at least a subset of the first-class dataset of enriched layered and weighted datasets with at least a subset of the second-class dataset of enriched layered and weighted datasets. The SVM-run time profile 540 may calculate a behavioral digital fingerprint (BDF) of at least a subset of the first-class dataset of enriched layered. In some embodiments, the system may apply the behavioral digital fingerprint (BDF) to the associated second-class dataset of enriched layered and weighted datasets. In some embodiments, the system may determine a risk associated with extending credit to the associated second-class dataset of enriched layered and weighted datasets based at least in part on the behavioral digital fingerprint (BDF). In some embodiments, the system may store the plurality of enriched layered and weighted datasets to memory. In some embodiments, the system may continuously search connected databases for new information, or employ services to validate user details. For example, a service may be used to text message the user to authenticate their cell phone. Other forms of user data may be validated using utilities. For example, send a user email to validate a user's given email address.

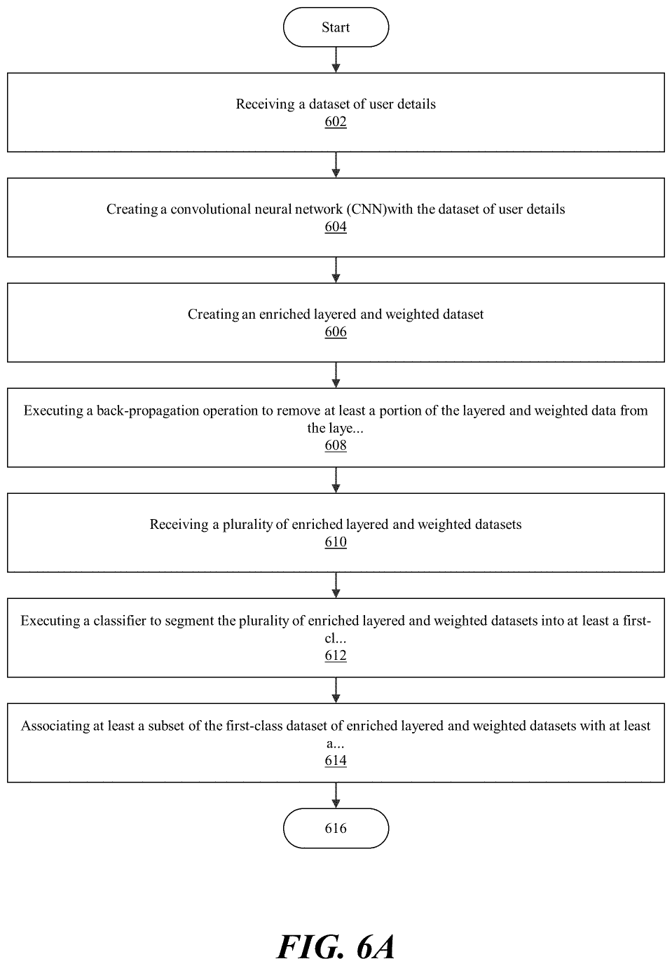

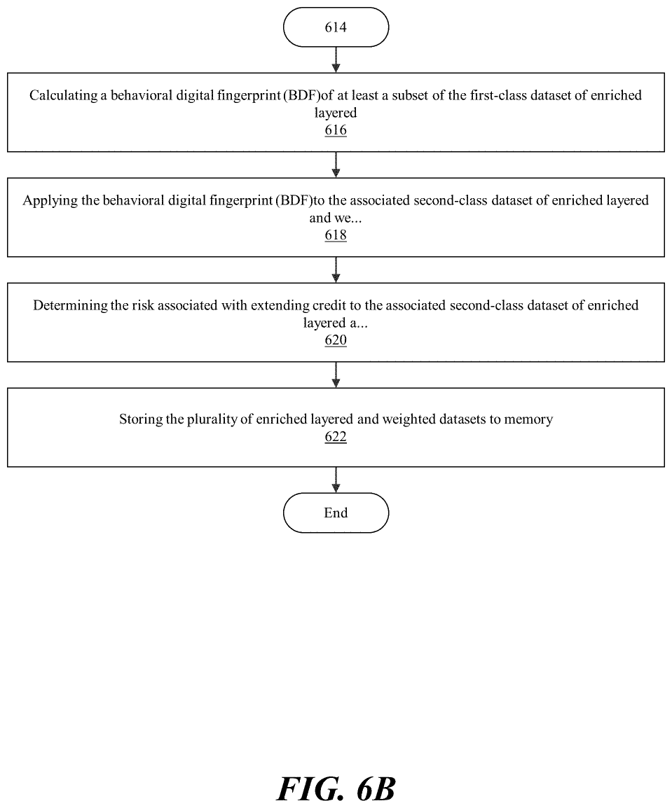

FIGS. 6A to 6B are flowcharts that describe a method, according to some embodiments of the present disclosure. In some embodiments, at 602, the method may include receiving a dataset of user details. At 604, the method may include creating a convolutional neural network (CNN) with the dataset of user details. At 606, the method may include creating an enriched layered and weighted dataset. The convolutional neural network may organize at least a portion of the dataset of user details into a layered and weighted dataset.

In some embodiments, at 608, the creating may include executing a back-propagation operation to remove at least a portion of the layered and weighted data from the layered and weighted dataset. At 610, the creating may include receiving a plurality of enriched layered and weighted datasets. At 612, the creating may include executing a classifier to segment the plurality of enriched layered and weighted datasets into at least a first-class dataset of enriched layered and weighted datasets and a second-class dataset of enriched layered and weighted datasets.

In some embodiments, at 614, the creating may include associating at least a subset of the first-class dataset of enriched layered and weighted datasets with at least a subset of the second-class dataset of enriched layered and weighted datasets. At 616, the creating may include calculating a behavioral digital fingerprint (BDF) of at least a subset of the first-class dataset of enriched layered. At 618, the creating may include applying the behavioral digital fingerprint (BDF) to the associated second-class dataset of enriched layered and weighted datasets. At 620, the creating may include determining the risk associated with extending credit to the associated second-class dataset of enriched layered and weighted datasets based at least in part on the behavioral digital fingerprint (BDF). At 622, the creating may include storing the plurality of enriched layered and weighted datasets to memory.

In some embodiments, the dataset of user details comprises at least one of an identification parameter, an age, marital status, residential address, an employer, a principal place of business (PPB) address, a secondary residences (INT), a secondary place of business (SPB), an email address, a contact number, and a favorite color. In some embodiments, receiving a dataset of user details further comprising accepting the dataset of user details from a credit request form. The credit request form may be at least one of a loan, a personal line of credit, a business line of credit, a line of credit increase, a credit card, a credit card limit increase, and a credit rate.

In some embodiments, the public cloud-based infrastructure (Azure™ Amazon™ etc.), a hosted solution (TripleC™, NetVision™, Rack Space™, and the like) or a self-hosted solution (a private data center based on, for example, VMware™ or Hyper-V™ infrastructure. In some embodiments, the at least one open database (ODB) may be a public cloud-based infrastructure. In some embodiments, creating an enriched layered and weighted dataset further comprises searching at least one open database (ODB) with a dynamic search engine (DSE) and returning at least one user detail not present in the layered and weighted dataset.

In some embodiments, the dynamic search engine (DSE) uses at least a portion of the layered and weighted dataset as an input to the dynamic search engine (DSE). In some embodiments, the method may include, for each retrieved email address, determining whether the host domain may be free, or represents a uniform source locator (URL). In some embodiments, executing a back-propagation operation to remove at least a portion of the layered and weighted data from the layered and weighted dataset further comprises associating a low strength score to a subset of the enriched layered and weighted dataset.

In some embodiments, executing a classifier to segment the plurality of enriched layered and weighted datasets into at least a first-class dataset of enriched layered and weighted datasets and a second-class dataset of enriched layered and weighted datasets further comprises executing a support vector machine. In some embodiments, a behavioral digital fingerprint (BDF) of at least a subset of the first-class dataset of enriched layered and weighted datasets may be representative of at least one business representative and the associated second-class dataset of enriched layered and weighted datasets may be representative of a business.

In some embodiments, the rate of local unemployment may be compared and weighted based on a regional rate of unemployment. In some embodiments, executing a back-propagation operation to remove at least a portion of the layered and weighted data from the layered and weighted dataset further comprises cross-referencing the enriched layered and weighted dataset with data retrieved from at least one open database (ODB) and at least one private database (PDB).

In some embodiments, the range of scoring for the data used to populated the data fields retrieved and cross-referenced from at least one of, the method may include performing one or more additional steps. Each ODB and at least one PDB, has a different scale. The method. In some embodiments, the method may include weighting each dataset of user details into a sub-grouping. In some embodiments, the weighting may be performed for at least one of the open database (ODB) and at least one private database (PDB).

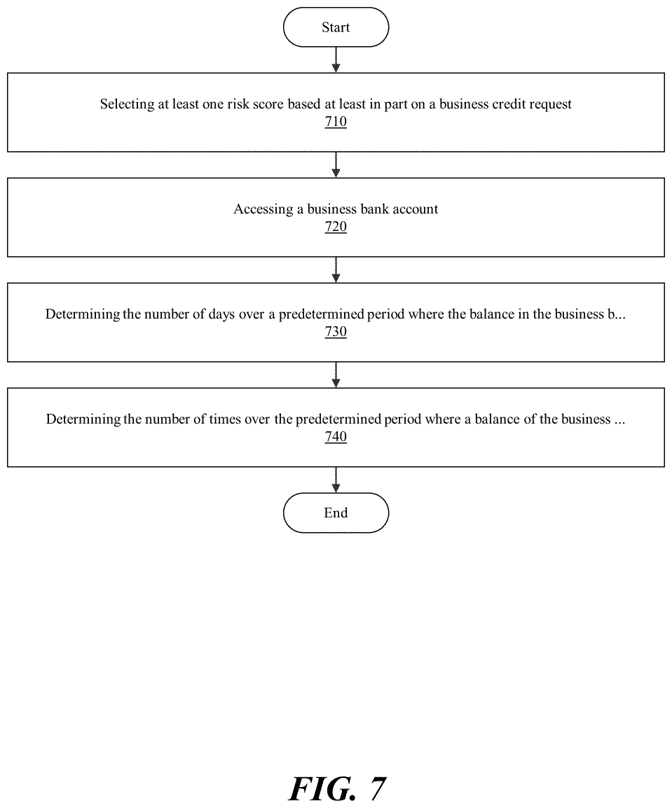

FIG. 7 is a flowchart that further describes the method from FIG. 6A, according to some embodiments of the present disclosure. In some embodiments, determining the risk associated with extending credit to the associated second-class dataset of enriched layered and weighted datasets based at least in part on the behavioral digital fingerprint (BDF) further comprises calculating a plurality of risk scores. In some embodiments, at 720, the method may include accessing a business bank account. At 730, the method may include determining the number of days over a predetermined period where the balance in the business bank account was below a predetermined balance. At 740, the method may include determining the number of times over the predetermined period where a balance of the business bank account was overdrawn.

In addition, the methods and systems for underwriting line of credit based on behavioral digital fingerprint can be further used in connection with the CAT smartphone and further comprise determining the use of apps on the smartphone; and providing a score based on the apps used. It is noted that the DESs used can be operated by third parties and be dedicated for the particular data sought to be mined. For example, sub-grouping the apps to financial-related applications; health-related applications; phone-related application, wherein the return telephone number does not match an existing contact. The data gathered can be the number of times and the length of time spent on each application in the sub-group.

Additionally, the computer program used in the methods and systems for underwriting line of credit based on behavioral digital fingerprint can be a set of instructions that can be used, directly or indirectly, in a computer. The systems and methods described herein can be implemented using programming languages such as Flash™, JAVA™, C++, C, C#, Visual Basic™, JavaScript™, PHP, XML, HTML, Solidity, etc., or a combination of programming languages, including compiled or interpreted languages, and can be deployed in any form, including as a stand-alone program or as a module, component, subroutine, or other unit suitable for use in a computing environment, including a virtual machine and/or virtual container. The software can include, but is not limited to, firmware, resident software, microcode, etc. Protocols such as SOAP/HTTP may be used in implementing interfaces between programming modules. The components and functionality described herein may be implemented on any desktop operating system executing in a virtualized or non-virtualized environment, using any programming language suitable for software development, including, but not limited to, different versions of Microsoft Windows™ Apple™ Mac™, IOS™, Unix™/X-Windows™, Linux™, etc. The system could be implemented using a web application framework, such as Ruby on Rails.

The processing system can be in communication with a computerized data storage system. The data storage system can include a non-relational or relational data store, such as a MySQL™ or other relational database. Other physical and logical database types could be used. The said local data storage system may be used as an in-memory cache, as well as a persistent file store. It may be used to store a fast-access view of decrypted smart contract data. In addition to storing the shared data profiles in blockchain smart contracts, other data may be stored in a local database server, such as Microsoft SQL Server™, Oracle™, IBM DB2™, SQLITE™, or any other database software, relational or otherwise. A blockchain may also be used for this purpose even if it does not support smart contracts as described in this document. In this case, write permissions between parties will be enforced through encryption (off chain) and visibility of flags/tokens only visible to those parties with permission to make a specific change. The data store may store the information identifying syntactical tags and any information required to operate on syntactical tags. In some embodiments, the processing system may use object-oriented programming and may store data in objects. In these embodiments, the processing system may use an object-relational mapper (ORM) to store the data objects in a relational database. The systems and methods described herein can be implemented using any number of physical data models. In one example embodiment, an RDBMS can be used. In those embodiments, tables in the RDBMS can include columns that represent coordinates. In the case of environment tracking systems, data representing user events, virtual elements, etc. can be stored in tables in the RDBMS. The tables can have pre-defined relationships between them. The tables can also have adjuncts associated with the coordinates. Suitable processors for the execution of a program of instructions include, but are not limited to, general and special purpose microprocessors, and the sole processor or one of multiple processors or cores, of any kind of computer. A processor may receive and store instructions and data from a computerized data storage device such as a read-only memory, a random access memory, both, or any combination of the data storage devices described herein. A processor may include any processing circuitry or control circuitry operative to control the operations and performance of an electronic device.

Further, the CPM may be operably coupled to the various modules and components with appropriate circuitry. may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, an engine, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may also be used herein, the terms “central processing module”, “module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributed (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the figures. Such a memory device or memory element can be included in an article of manufacture.

Other databases that can be accessed (the data retrieved and the way to access these databases) can be, for example, API Agents, for example; Dan & Bradstreet™ (D&B) Shallow API; D&B Deep Query API; or Madlan™ API; or a combination comprising the foregoing. Scraping Agents can be, for example: MMI website; TABO website; Mortgage registrar website; or a combination comprising the foregoing. Tone dial and voice recognition for example, Credit rating companies. Binary file interpretation can be, for example: 6111; 874; 102; or a combination comprising the foregoing. Textual file interpretation can be, for example: Bank ID; Bank account status; Bank credit statement; or a combination comprising the foregoing.

In an embodiment, the CPM is configured to form the core network using the data, figures and information retrieved from the company register database, the property register database, the financial database, the credit rating module, and the scoring module, wherein the core network is associated with the target business (interchangeable with “main business” and “client's business”) and is configured to establish interrelated entities to the target business, their direct and/or indirect ownership interest in the target business, the ultimate beneficial owner, and the scored credit rating.

As used herein, the term “credit rating” refers to a quantified assessment of the creditworthiness of a (potential) borrower in general terms or with respect to a particular debt or financial obligation. A credit rating can be assigned to any entity that seeks to borrow money—an individual, corporation, state or provincial authority, or sovereign government.

The step of identifying the owner of the business for which credit extension is requested is preceded in an embodiment by retrieving: a registration number, an employer identifier (EID) tax number, an address, or a combination comprising the foregoing from a company register database; and/or an ownership identification, a location and size of a lot, property tax figures, liens on a property, a recent transaction figures or a combination of data comprising the foregoing from a property register database; and/or a balance, a historical cash flow data, a monthly obligation payments record, an automated bill payment record, and existing obligation and/or pledge, an additional asset record, or a combination of records and data comprising the foregoing from a financial database; and/or a current credit rating of the business for which the loan is requested, a credit rating of the entity interrelated to the business for which the loan is requested, credit rating of the owner of the business for which credit extension is requested or the entity interrelated to the business for which credit extension is requested.

The graphic interface forming part of the CAT can be interactive, referring in an embodiment to an interactive screen which comprises sensitive objects (points, objects, alphanumeric values, lists, menus, symbols, icons etc.) which are respectively associated with particular specified functions; and which are sensitive to the presence of a cursor, or pressure or light differential as in touch screens (hereinafter, actuator).

In addition, the systems, methods and GUI provided herein can be used to facilitate p2p (peer to peer) business environment for automatic underwriting and data gathering, as well as monitoring and classifying financial stability and failure risk for businesses interested in financing through credit line extension, shares or initial coin offering (ICO). As used herein, the term “peer-to-peer” means having at least common portions of communications protocol and/or capability and does not refer to equivalence of physical size, functional capability, data processing capacity or transceiver range or power.

The term “smart contracts” refers to digital entities that define complex transaction logic and facilitate cross-organizational workflow including, but not limited to, storage of data, data access permissions, ordered workflow and computation.

The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the network(s) includes one or more network). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The term “system” shall also be taken to include any collection of systems or sub-systems that individually or jointly execute a set, or multiple sets, of instructions to perform one or more functions. Also, the term “system” refers to a logical assembly arrangement of multiple devices, and is not restricted to an arrangement wherein all of the component devices are in the same housing.

While particular embodiments have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

1. A method for credit underwriting, the method comprising:
receiving a dataset of user details;
creating a convolutional neural network (CNN) with the dataset of user details, wherein the convolutional neural network organizes at least a portion of the dataset of user details into a layered and weighted dataset;
creating an enriched layered and weighted dataset;
executing a back-propagation operation to remove at least a portion of the layered and weighted data from the layered and weighted dataset;
receiving a plurality of enriched layered and weighted datasets;
executing a classifier to segment the plurality of enriched layered and weighted datasets into at least a first-class dataset of enriched layered and weighted datasets and a second-class dataset of enriched layered and weighted datasets;
associating at least a subset of the first-class dataset of enriched layered and weighted datasets with at least a subset of the second-class dataset of enriched layered and weighted datasets;
calculating a behavioral digital fingerprint (BDF) of at least a subset of the first-class dataset of enriched layered;
applying the behavioral digital fingerprint (BDF) to the associated second-class dataset of enriched layered and weighted datasets;
determining the risk associated with extending credit to the associated second-class dataset of enriched layered and weighted datasets based at least in part on the behavioral digital fingerprint (BDF); and
storing the plurality of enriched layered and weighted datasets to memory.

2. The method of claim 1, wherein the dataset of user details comprises at least one of an identification parameter, an age, marital status, residential address, an employer, a principal place of business (PPB) address, a secondary residences (INT), a secondary place of business (SPB), an email address, a contact number, and a favorite color.

3. The method of claim 1, wherein receiving a dataset of user details further comprising accepting the dataset of user details from a credit request form, wherein the credit request form is at least one of a loan, a personal line of credit, a business line of credit, a line of credit increase, a credit card, a credit card limit increase, and a credit rate.

4. The method of claim 1, wherein the at least one open database (ODB) is a public cloud-based infrastructure.

5. The method of claim 3, wherein the public cloud-based infrastructure (Azure™ Amazon™ etc.), a hosted solution (TripleC™, NetVision™, Rack Space™, and the like) or a self-hosted solution (a private data center based on, for example, VMware™ or Hyper-V™ infrastructure.

6. The method of claim 1, wherein creating an enriched layered and weighted dataset further comprises searching at least one open database (ODB) with a dynamic search engine (DSE) and returning at least one user detail not present in the layered and weighted dataset.

7. The method of claim 6, wherein the dynamic search engine (DSE) uses at least a portion of the layered and weighted dataset as an input to the dynamic search engine (DSE).

8. The method of claim 1, wherein executing a back-propagation operation to remove at least a portion of the layered and weighted data from the layered and weighted dataset further comprises associating a low strength score to a subset of the enriched layered and weighted dataset; and discarding at least one subset of the enriched layered and weighted dataset associated with the low strength score.

9. The method of claim 1, wherein executing a classifier to segment the plurality of enriched layered and weighted datasets into at least a first-class dataset of enriched layered and weighted datasets and a second-class dataset of enriched layered and weighted datasets further comprises executing a support vector machine.

10. The method of claim 1, wherein a behavioral digital fingerprint (BDF) of at least a subset of the first-class dataset of enriched layered and weighted datasets is representative of at least one business representative and the associated second-class dataset of enriched layered and weighted datasets is representative of a business.

11. The method of claim 1, wherein executing a back-propagation operation to remove at least a portion of the layered and weighted data from the layered and weighted dataset further comprises cross-referencing the enriched layered and weighted dataset with data retrieved from at least one open database (ODB) and at least one private database (PDB).

12. The method of claim 1, further comprising weighting each dataset of user details into a sub-grouping.

13. The method of claim 12, wherein the weighting is performed for at least one of the open database (ODB) and at least one private database (PDB).

14. The method of claim 10, wherein the rate of local unemployment is compared and weighted based on a regional rate of unemployment.

15. The method of claim 11, wherein the range of scoring for the data used to populated the data fields retrieved and cross-referenced from at least one of: each ODB and at least one PDB, has a different scale, and wherein the method comprises normalizing the scoring for the data retrieved based on the scoring scale.

16. The method of claim 6, further comprising, for each retrieved email address, determining whether the host domain is free, or represents a uniform source locator (URL).

17. The method of claim 1, wherein determining the risk associated with extending credit to the associated second-class dataset of enriched layered and weighted datasets based at least in part on the behavioral digital fingerprint (BDF) further comprises calculating a plurality of risk scores; and selecting at least one risk score based at least in part on a business credit request.

18. The method of claim 17, further comprising:
a. accessing a business bank account;
b. determining the number of days over a predetermined period where the balance in the business bank account was below a predetermined balance; and
c. determining the number of times over the predetermined period where a balance of the business bank account was overdrawn.
